(19) United States
(12) Patent Application Publication
(10) Pub. No.: US 2025/0243925 A1
(43) Pub. Date: Jul. 31, 2025

(54) TENSIONER SYSTEM FOR FLEXIBLE DRIVE MEMBER

(71) Applicant: BOMBARDIER RECREATIONAL PRODUCTS INC., Valcourt (CA)

(72) Inventors: Samuel SIMONEAU, St-Denis-de-Brompton (CA); Pierre-Luc ROBILLARD, Sherbrooke (CA)

(21) Appl. No.: 19/036,357

(22) Filed: Jan. 24, 2025

Related U.S. Application Data
(60) Provisional application No. 63/627,396, filed on Jan. 31, 2024.

(51) Int. Cl. F16H 7/08; B62K 11/00; B62M 7/06; B62M 9/02; F16H 7/02

(52) U.S. Cl. CPC F16H 7/08; B62K 11/00; B62M 7/06; B62M 9/02; F16H 7/023; F16H 2007/0806; F16H 2007/0872; F16H 2007/0876; F16H 2007/0891; F16H 2007/0897

(57) ABSTRACT

A tensioner system for a flexible drive member has: a slider configured for abutting the flexible drive member; a tensioner body supporting the slider; a biasing member arranged for biasing the slider toward the flexible drive member via the tensioner body; and a latch having a latched position and an unlatched position. In the unlatched position, the latch permits the biasing member to move the slider toward the flexible member. In the latched position, the latch prevents the biasing member from moving the slider toward the flexible member. A drivetrain and a vehicle having the tensioner system are also disclosed.

### CROSS-REFERENCE

The present application claims priority to U.S. Provisional Patent Application No. 63/627,396, filed Jan. 31, 2024, the entirety of which is incorporated by reference.

### FIELD OF TECHNOLOGY

The present technology relates to tensioner systems for flexible drive members, drivetrains having flexible drive members, and vehicles having same.

### BACKGROUND

Motorcycles typically have a front wheel and a rear wheel, with the rear wheel being driven by a motor, such as an internal combustion engine or an electric motor. The rear wheel is often connected to the frame of the motorcycle via a swingarm. The swingarm can be a double-sided swingarm or a single side swingarm. In a double-sided swingarm, the swingarm has two arms and the rear wheel is rotationally supported between the two arms. In a single-sided swingarm, the rear wheel is rotationally connected to one side of an arm of the swingarm in a cantilevered fashion.

A drivetrain is operatively connected between the motor and the rear wheel from driving the rear wheel from the motor. In many motorcycles, the drivetrain includes a drive sprocket operatively connected to the motor, a driven sprocket operatively connected to the rear wheel, and a flexible drive member engaging the drive and driven sprockets for transmitting torque between the drive sprocket and the driven sprocket. The flexible drive member can be a drive chain or a drive belt. In many motorcycles, the swingarm forms part of the drivetrain by defining the housing that houses the drive sprocket, the driven sprocket, and the flexible drive member.

For the above type of drivetrain to operate properly, a certain amount of tension needs to be applied to the flexible drive member. However, during use the tension on the flexible drive member can reduce due to the flexible drive member getting longer due to changes in temperature or to wear of the flexible drive member for example. In order address this problem, many drivetrains are provided with a tensioner system. The tensioner system pushes against the flexible drive member in order to maintain the tension in the flexible drive member. The tensioner system is also typically housed in the swingarm.

However, in motorcycles having a single-sided swingarm where the drive sprocket, the driven sprocket, the flexible drive member, and the tensioner system are housed in the housing, the tensioner system can lead to some difficulties during the initial assembly of the drivetrain and when doing maintenance in the drivetrain, such as when replacing the flexible drive member. As described above, in such embodiments, the rear wheel is connected to the swingarm in a cantilevered fashion. In order for this connection to solidly connect the rear wheel, the wheel axle is supported by bearings in the side of the swingarm adjacent to the rear wheel and in the opposite side of the housing. This opposite side of the housing is a cover that is removed during maintenance. As such, when the cover is removed, the bearings that are normally supported by the cover are no longer being supported. In such embodiments, when maintenance is finished, the tensioner system is set to apply tension on the flexible member before the cover is reconnected to the rest of the swingarm. As a result, the tension in the flexible drive member pulls on the axle of the rear wheel which is only supported by the bearings in the side of the swingarm adjacent the rear wheel, which can cause movement of the free end of the axle, thereby making installation of the cover difficult due to the misalignment of the axle, and applies stress to these bearings. One solution consists in over-engineering these bearings in order to resist the tension in the flexible drive member when the cover is removed. However, this results in an increase in costs and weight in order to address a problem that occurs only when doing maintenance.

There is therefore a desire for a drivetrain that addresses the above problems.

### SUMMARY

It is an object of the present technology to ameliorate at least some of the inconveniences present in the prior art.

The present technology provides a tensioner system for a flexible drive member that has a latch. The latch has a latched position where a biasing member of the tensioner system does not cause tension to be applied to the flexible drive member. The tensioner system applies tension on the flexible drive member in response to the latch being unlatched. In embodiments where the tensioner system is inside a housing, the latch can be unlatched from outside of the housing.

According to aspects of the present technology, there is provided a tensioner system for a flexible drive member having: a slider configured for abutting the flexible drive member; a tensioner body supporting the slider; a biasing member arranged for biasing the slider toward the flexible drive member via the tensioner body; and a latch having a latched position and an unlatched position. In the unlatched position, the latch permits the biasing member to move the slider toward the flexible member. In the latched position, the latch prevents the biasing member from moving the slider toward the flexible member.

In some embodiments, a base selectively engages the slider. In the unlatched position, the slider is disengaged from the base, and the tensioner body is movable relative to the base. In the latched position, the slider engages the base, and the tensioner body is fixed relative to the base.

In some embodiments, the biasing member is a spring disposed between the base and the tensioner body.

In some embodiments, the latch has: a tab defined by one of the base and the slider; and a recess defined by an other one of the base and the slider. In the unlatched position, the tab is disengaged from the recess. In the latched position, the tab is received in the recess.

In some embodiments, the base defines the tab; and the slider defines the recess.

In some embodiments, the slider pivots to engage and disengage the tab with the recess.

In some embodiments, an actuator operatively connects to the base, the tensioner body, and the slider for selectively translating the base, the tensioner body, and the slider relative to the flexible drive member. In the latched position, the actuator is configured to move the base, the tensioner body, and the slider as a unit toward the flexible drive member such that the slider comes into contact with the flexible drive member, causing the slider to pivot thereby disengaging the tab from the recess and placing the latch in the unlatched position.

In some embodiments, the tensioner system has a translation member having threads. The base is connected to the translation member. The tensioner body is supported by the translation member. In the unlatched position, the tensioner body is translatable along the translation member. The actuator is a threaded fastener having threads engaging the threads of the translation member.

In some embodiments, the translation member defines a plurality of grooves. A space is defined between the tensioner body and the translation member. The tensioner system also has a ratchet clip disposed at least in part in the space and received in one groove of the plurality of grooves. Translation of the tensioner body away from the base causes the tensioner body to push the ratchet clip from the one groove to an other groove of the plurality of grooves, the other groove of the plurality of grooves being further from the base than the one groove. the ratchet clip prevents movement of the tensioner body toward the base.

According to another aspect of the present technology, there is provided a drive train having: a housing; a drive wheel disposed in the housing; a driven wheel disposed in the housing; a flexible drive member engaging the drive wheel and the driven wheel for transmitting torque between the drive wheel and the driven wheel; and a tensioner system for tensioning the flexible drive member. The tensioner system has: a slider for abutting the flexible drive member; a tensioner body supporting the slider; a biasing member arranged selectively biasing the slider toward the flexible drive member via the tensioner body; and a latch having a latched position and an unlatched position. In the unlatched position, the latch permits the biasing member to move the slider toward the flexible member. In the latched position, the latch preventing the biasing member from moving the slider toward the flexible member. The tensioner system also has an actuator operatively connected to the latch for moving the latch from the latched position to the unlatched position.

In some embodiments, the housing defines an aperture. The actuator is accessible via the aperture for moving the latch from the latched position to the unlatched position.

In some embodiments, the tensioner system also has a base selectively engaging the slider. In the unlatched position, the slider is disengaged from the base, and the tensioner body is movable relative to the base. In the latched position, the slider engages the base, and the tensioner body is fixed relative to the base.

In some embodiments, the biasing member is a spring disposed between the base and the tensioner body.

In some embodiments, the latch has: a tab defined by one of the base and the slider; and a recess defined by an other one of the base and the slider. In the unlatched position, the tab is disengaged from the recess. In the latched position, the tab is received in the recess.

In some embodiments, the base defines the tab; and the slider defines the recess.

In some embodiments, the slider pivots to engage and disengage the tab with the recess.

In some embodiments, the actuator is operatively connected to the base, the tensioner body, and the slider for selectively translating the base, the tensioner body, and the slider relative to the flexible drive member. In the latched position, the actuator is configured to move the base, the tensioner body, and the slider as a unit toward the flexible drive member such that the slider comes into contact with the flexible drive member causing the slider to pivot thereby disengaging the tab from the recess and placing the latch in the unlatched position.

In some embodiments, the tensioner system also has a translation member having threads. The base is connected to the translation member. The tensioner body is supported by the translation member. In the unlatched position, the tensioner body is translatable along the translation member. The actuator is a threaded fastener having threads engaging the threads of the translation member.

In some embodiments, the translation member defines a plurality of grooves. A space is defined between the tensioner body and the translation member. The tensioner system also has a ratchet clip disposed at least in part in the space and received in one groove of the plurality of grooves. Translation of the tensioner body away from the base causing the tensioner body to push the ratchet clip from the one groove to an other groove of the plurality of grooves, the other groove of the plurality of grooves being further from the base than the one groove. The ratchet clip prevents movement of the tensioner body toward the base.

According to another aspect of the present technology, there is provided a vehicle having: a frame; at least one front wheel; a rear wheel; the above drivetrain, the driven wheel of the drivetrain being operatively connected to the rear wheel; and a motor operatively connected to the drive wheel of the drivetrain.

For purposes of the present application, terms related to spatial orientation such as forward, rearward, front, rear, upper, lower, left, and right, are as they would normally be understood by a driver of the vehicle sitting thereon in a normal driving position with the vehicle being upright and steered in a straight ahead direction.

Embodiments of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of embodiments of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a left side elevation view of a vehicle according to the present technology;

FIG. 2 is a close-up perspective view taken from a rear, left side of a drivetrain and a rear wheel of the vehicle of FIG. 1;

FIG. 3 is a close-up perspective view taken from a rear, left side of the drivetrain and the rear wheel of FIG. 2, with a cover of a housing of the drivetrain removed;

FIG. 4 is a close-up top plan view of the drivetrain and the rear wheel of FIG. 2;

FIG. 5 is a close-up top plan view of the drivetrain and the rear wheel of FIG. 4, with the cover of the housing and a top part of the housing removed;

FIG. 6 is a close-up left side elevation view of a tensioner system region of the drivetrain of FIG. 3, with a latch of the tensioner system in a latched position;

FIG. 7 is a close-up left side elevation view of the components of FIG. 6, with the latch being in the process of being unlatched;

FIG. 8 is a close-up left side elevation view of the components of FIG. 6, with the latch being unlatched;

FIG. 9 is a close-up perspective view taken from a front, left side of the components of FIG. 8;

FIG. 10 is a perspective view taken from a front, left side of a cross-section of the drivetrain and the rear wheel of FIG. 2, taken through line 10-10 of FIG. 4, with the cover of the housing being removed;

FIG. 11 is a close-up perspective view taken from a front, left side of the components of FIG. 6, with a slider and a flexible drive member being removed;

FIG. 12 cross-sectional view of the components of FIG. 4, taken through line 12-12 of FIG. 4;

FIG. 13 a cross-sectional view of the drivetrain and the rear wheel of FIG. 2, taken through line 10-10 of FIG. 4;

FIG. 14 is a close-up view of the tensioner system region of FIG. 13, with the slider in a lowered position; and

FIG. 15 is a close-up view of the tensioner system region of FIG. 13, with the slider in a raised position.

It should be noted that, unless otherwise explicitly specified herein, the drawings are not necessarily to scale.

### DETAILED DESCRIPTION

The present technology will be described herein with respect to a straddle-seat electric vehicles, specifically a two-wheeled electric motorcycle 100. Aspects of the present technology could also be implemented in different vehicles and other mechanical devices having a flexible drive member.

While the motorcycle 100 illustrated herein is a street style electric motorcycle 100, it is contemplated that motorcycles according to the present technology could vary by a plurality of vehicle characteristics. These vehicle characteristics could include, but are not limited to, a rider posture configuration (also referred to as a rider position), a motorcycle type, tire type, a wheelbase, a steering arrangement, a weight distribution, a squat ratio, a rake angle, a seat height, and a mechanical trail. The rider posture configuration, or rider position, is the relative spacing and position of a rider's hands (when holding the handlebars), the rider's feet (when positioned on the footrests) and the rider's buttocks (when the rider is seated on a seat of the motorcycle). The steering arrangement could also vary and can be described by a variety of parameters, including but not limited to: a length of front suspension travel, a length of rear suspension travel, a front suspension stiffness, a rear suspension stiffness, a front and/or rear wheel size, rake angle, mechanical trail, triple clamp offset, squat ratio, and wheel base.

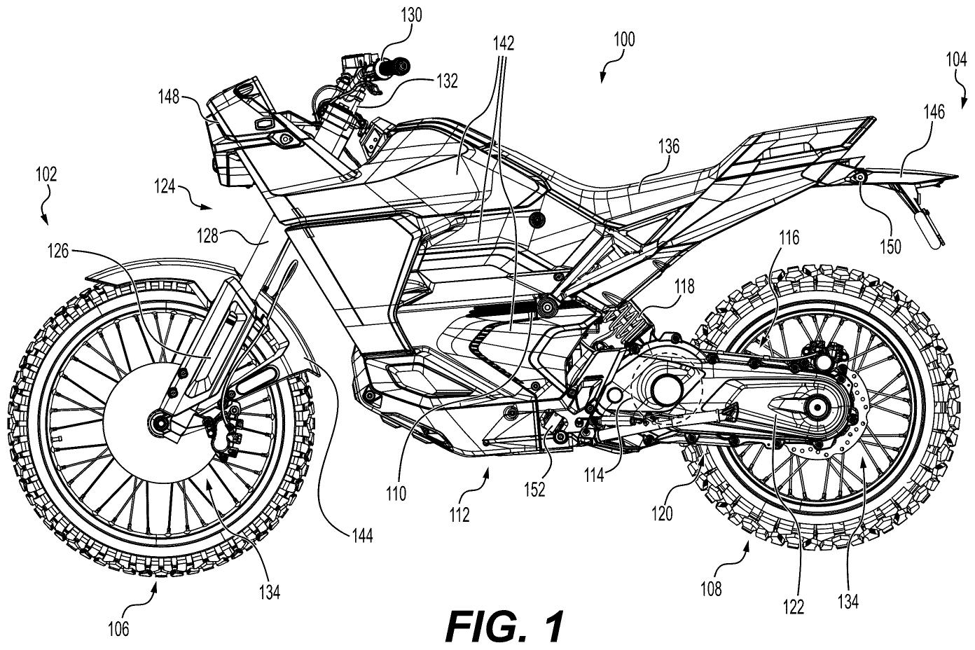

With reference to FIG. 1, the electric motorcycle 100, referred to hereinafter as the vehicle 100, has a front end 102 and a rear end 104 defined consistently with the forward travel direction of the vehicle 100. The vehicle 100 is a two-wheeled vehicle 100 including a front wheel 106 and a rear wheel 108. The front wheel 106 and the rear wheel 108 each have a tire secured thereto.

A battery pack 110 is arranged in the vehicle 100 between the front wheel 106 and the rear wheel 108. In the present embodiment, the battery pack 110 forms part of the frame 112 of the vehicle 100. A charger (not shown) is electrically connected to the battery pack 110, and is disposed on a top of the battery pack 110. It is contemplated that the location of the charger relative to the battery pack 110 could vary. An inverter (not shown) is electrically connected to the battery pack 110, and is disposed on a left side of the battery pack 110. It is contemplated that the location of the charger relative to the battery pack 110 could vary.

An electric motor 114 (shown schematically in FIG. 1) is operatively connected to the rear wheel 108 to drive the rear wheel. The electric motor 114 is mounted to a swingarm 116. It is contemplated that in some embodiments, the electric motor 114 could be mounted to the frame 112. The swingarm 116 is pivotally connected at its front to the frame 112. The rear wheel 108 is rotationally connected to the rear portion of the swingarm 116. A shock absorber 118 is connected between the swingarm 116 and the frame 112. Electric power is provided to the motor 114 by the battery pack 110 via the inverter. The motor 114 drives the rear wheel 108 via a drivetrain 120. The swingarm 116 defines a housing 122 of the drivetrain 120. The drivetrain 120 will be described in more detail below. In the present embodiment, the motor 114 is a three-phase electric motor 114. It is contemplated that different types of motors could be used in some embodiments. It is also contemplated that in some embodiments, the electric motor 114 could be replaced by a different type of motor, such as a two-stroke or four-stroke internal combustion engines. In such embodiments, the battery pack 110 would be omitted and the vehicle 100 would be provided with a fuel tank, an air intake system, an exhaust system, and other components required for the operation of an internal combustion engine.

The front wheel 106 is connected to the frame 112 by a front suspension assembly 124. The front wheel 106 is rotationally connected to the front suspension assembly 124. The front suspension assembly 124 includes a front fork assembly 126 and a pair of front shocks 128.

A handlebar assembly 130 is operatively connected to the front suspension assembly 124. The handlebar assembly 130 is used to turn the front wheel 106, via the front suspension assembly 124. A twist-grip throttle (not shown) is operatively connected on the right side of the handlebar assembly 130 for controlling vehicle speed. It is contemplated that the twist-grip throttle 130 could be replaced by a thumb throttle lever or some other type of throttle input device. A brake lever 132 is operatively connected on a right side of the handlebar assembly for activating brake assemblies 134 of the front and rear wheels 106, 108.

A straddle seat 136 is connected to a top of the frame 112. In the present embodiment, the straddle seat 136 is sized to accommodate a single adult-sized rider (i.e., the driver). It is however contemplated that the seat 136 could be longer or that a passenger seat portion could be connected to the frame 112 in order to accommodate a passenger behind the driver.

A plurality of body panels 142 are connected to the frame 112 for forming the body of the vehicle 100. The body panels 142 enclose and protect some internal components of the vehicle 100. A front fender 144 is disposed at the front of the vehicle 100 and extends partially over the front wheel 106. A rear fender panel 146 extends partially over rear wheel 108. Front headlights 148 are attached to the front suspension assembly 124. Rear braking and indicator lights 150 are connected to the rear fender panel 146. Footrests 152 are connected to the frame 112 on either side of the vehicle 100 vertically lower than the straddle seat 136 to support the driver's feet. A brake pedal (not shown) is connected to the right driver footrest 152 (not shown) for braking the vehicle 100.

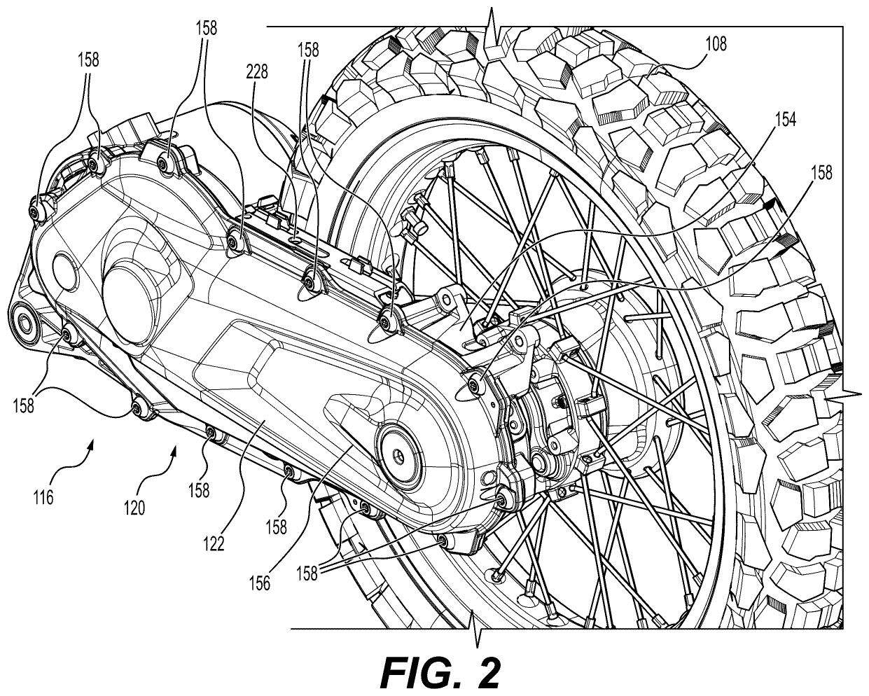

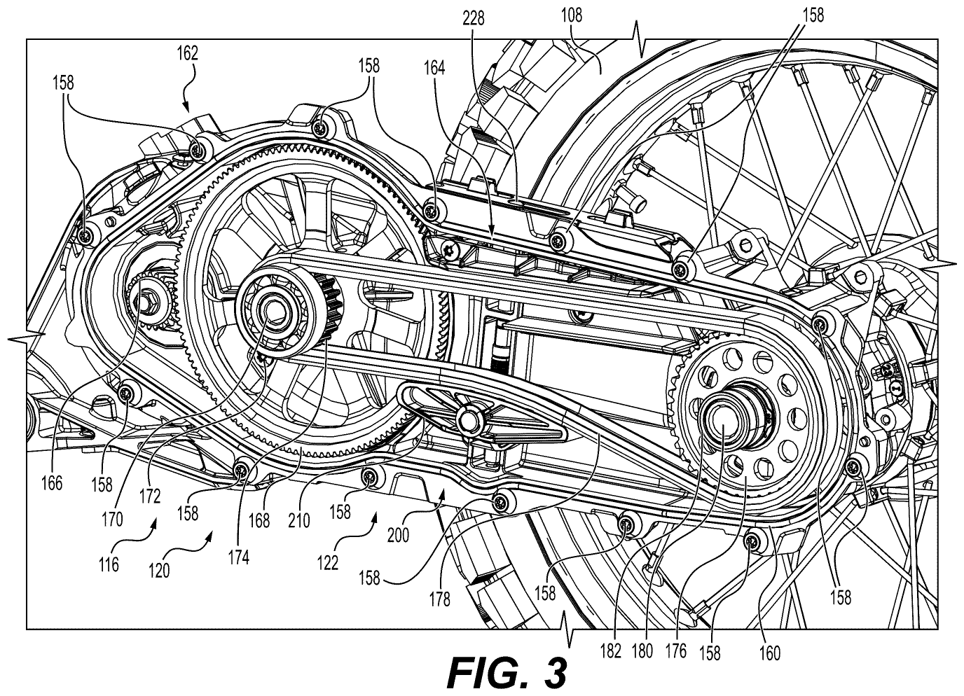

Turning now to FIGS. 2, 3 and 10, the drivetrain 120 will be described in more detail. As described above, the drivetrain 120 has a housing 122 that is defined by the swingarm 116. The housing 122 has a main housing portion 154 and a removable housing cover 156 fastened to the main housing portion 154 by threaded fastener 158. A seal 160 (FIG. 3) is provided in a groove along an edge of the main housing portion 154 to seal the interface between the main housing portion 154 and the housing cover 156 to prevent oil present inside the housing 122 from leaking out of the housing 122 via this interface. The motor 114 is fastened to a front right side of the main housing portion 154. The rear wheel 108 is rotationally connected to a rear right side of housing 122, behind the motor 114. The drivetrain 120 also includes a gear assembly 162, a drive belt assembly 164 driven by the gear assembly 162, and a tensioner system 200 which are disposed inside the housing 122.

The gear assembly 162 includes drive gear 166 mounted on an output shaft (not shown) of the motor 114 and a driven gear 168 mounted on an axle 170. The drive gear 166 meshes with the driven gear 168 to transfer torque from the motor 114 to the driven gear 168. As can be seen, the driven gear 168 has a greater diameter than the drive gear 166, such that the driven gear 168 turns slower than the drive gear 166, and therefore slower than the output shaft of the motor 114. The axle 170 engages the driven gear 168 with splines such that the driven gear and the axle 170 turn at the same speed. The axle 170 is rotationally supported at its right and left ends by right and left bearing 172 (only the left bearing 172 being shown). The right bearing 172 is supported in a ring (now shown) defined by a right wall of the main housing portion 154. The left bearing 172 is supported in a ring (now shown) defined by a left wall of the housing cover 156. It is contemplated that a different type of gear assembly could be provided instead of the gear assembly 162. It is also contemplated that a speed reduction mechanism other than a gear assembly could be provided instead of the gear assembly 162, such as another drive belt assembly for example. It is also contemplated that the gear assembly, or an alternative speed reduction mechanism, could be provided outside of the housing 122, such as between the housing 122 and the motor 114 or inside the housing (not shown) of the motor 114. It is also contemplated that in some embodiments, the gear assembly 162 could be omitted.

The drive belt assembly 164 includes a drive wheel 174, a driven wheel 176 and a flexible drive member 178 engaging the drive wheel 174 and the driven wheel 176 for transmitting torque between the drive wheel 174 and the driven wheel 176. In the drive belt assembly 164, the drive wheel 174 is a drive belt sprocket 174, the driven wheel 176 is a driven belt sprocket 176 and the flexible drive member 178 is a drive belt 178. In the present embodiment, the drive belt 178 is a toothed elastomeric drive belt, such as a rubber drive belt, but other materials are contemplated. It is contemplated that in alternative embodiments, the drive belt assembly 164 could be replaced by a drive chain assembly in which the drive wheel is a drive chain sprocket, the driven wheel is a driven chain sprocket, and the flexible drive member is a drive chain. It is also contemplated that in other alternative embodiments, the drive belt assembly 164 could be replaced by a pulley assembly in which the drive wheel is a drive pulley, the driven wheel is a driven pulley, and the flexible drive member is a V-belt.

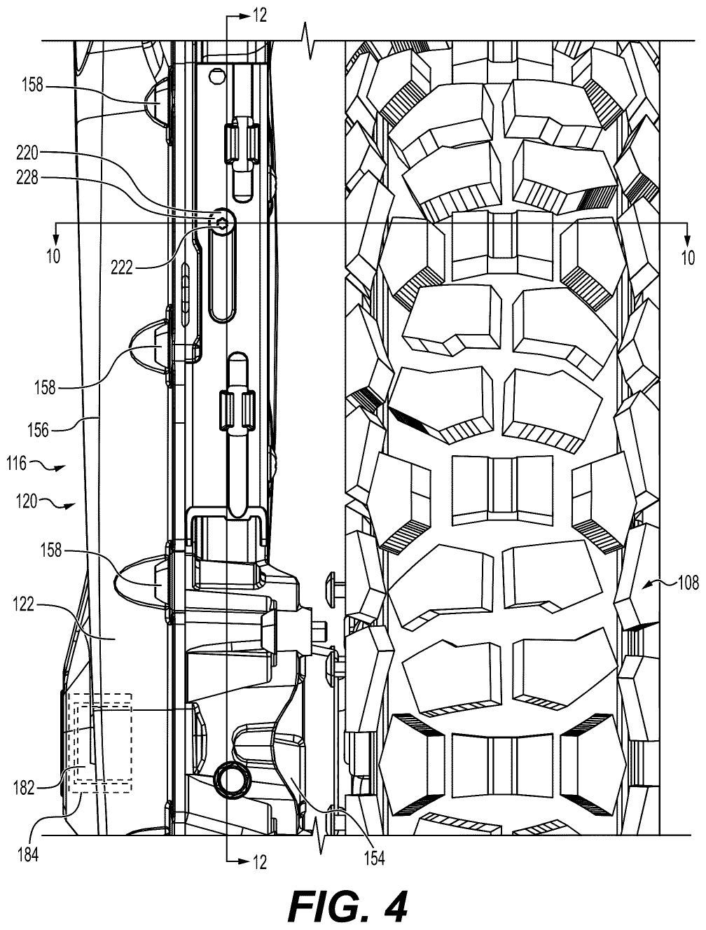

The drive belt sprocket 174 is mounted on the axle 170 via the splines on the axle 170. As such, the drive belt sprocket 174 turns at the same speed as the driven gear 168 and the axle 170. The drive belt sprocket 174 is disposed laterally between the left bearing 172 and the driven gear 168. The drive belt sprocket 174 has a diameter that is greater than the diameter of the drive gear 166 and smaller than the diameter of the driven gear 168. The driven belt sprocket 176 is mounted on a rear wheel axle 180 via splines. The rear wheel 108 is mounted on the right end of the rear wheel axle 180. The rear wheel axle 180 is rotationally supported at center portion and at its left ends by right and left bearing 182 (only the left bearing 182 being shown). The right bearing 182 is disposed laterally between the rear wheel 108 and the driven belt sprocket 176. The right bearing 182 supported in a ring (now shown) defined by a right wall of the main housing portion 154. The left bearing 172 is supported in a ring 184 (schematically shown is FIG. 4) defined by a left wall of the housing cover 156. The drive belt 178 is disposed around the drive belt sprocket 174 and the driven belt sprocket 176.

As will be described in more detail below, the tensioner system 200 pushes up against a bottom of a lower portion of the drive belt 178 for tensioning the drive belt 178. It is contemplated that in alternative embodiments, the tensioner system 200 could be positioned and configure to push down against a top of the lower portion of the drive belt 178, or to push up against a bottom of an upper portion of the drive belt 178, or to push down against a top of the upper portion of the drive belt 178.

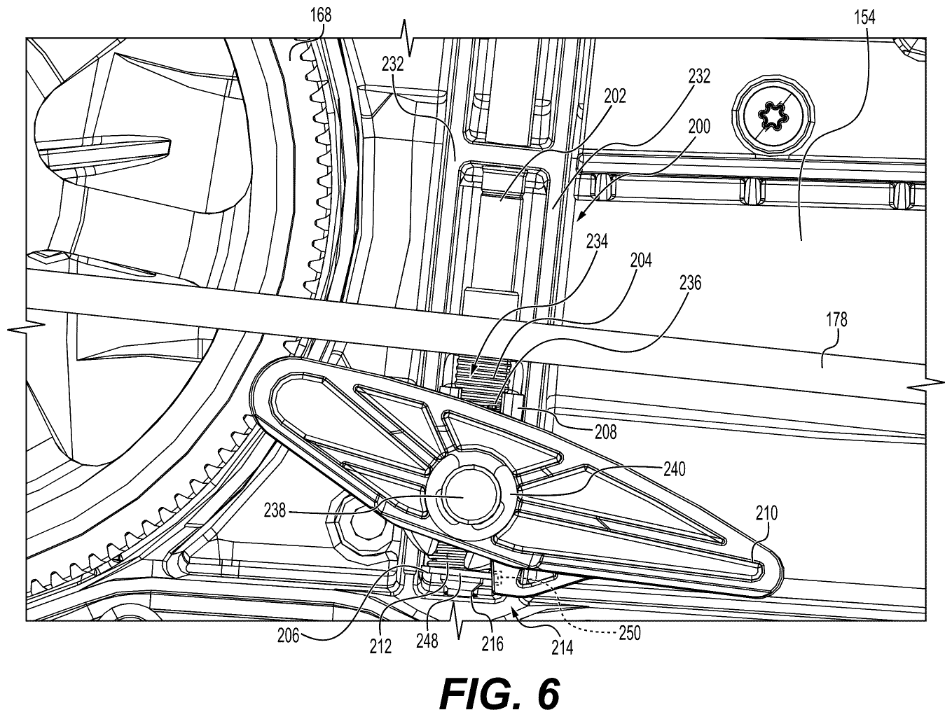

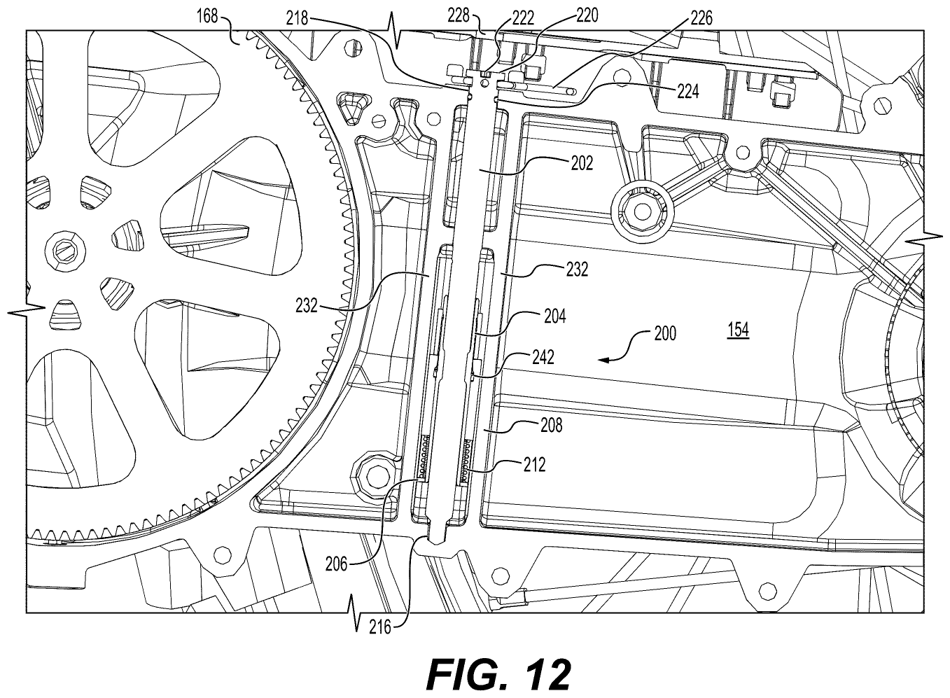

Turning now to FIGS. 6 to 15, the tensioner system 200 will be described in more detail below. The tensioner system has an actuator 202, a translation member 204 disposed around the actuator 202, a base 206 connected to a lower end of the translation member 204, a tensioner body 208 disposed around and supported by the translation member 204, a slider 210 supported by the tensioner body 208, a biasing member 212 disposed between the base 206 and the tensioner body 208, and a latch 214.

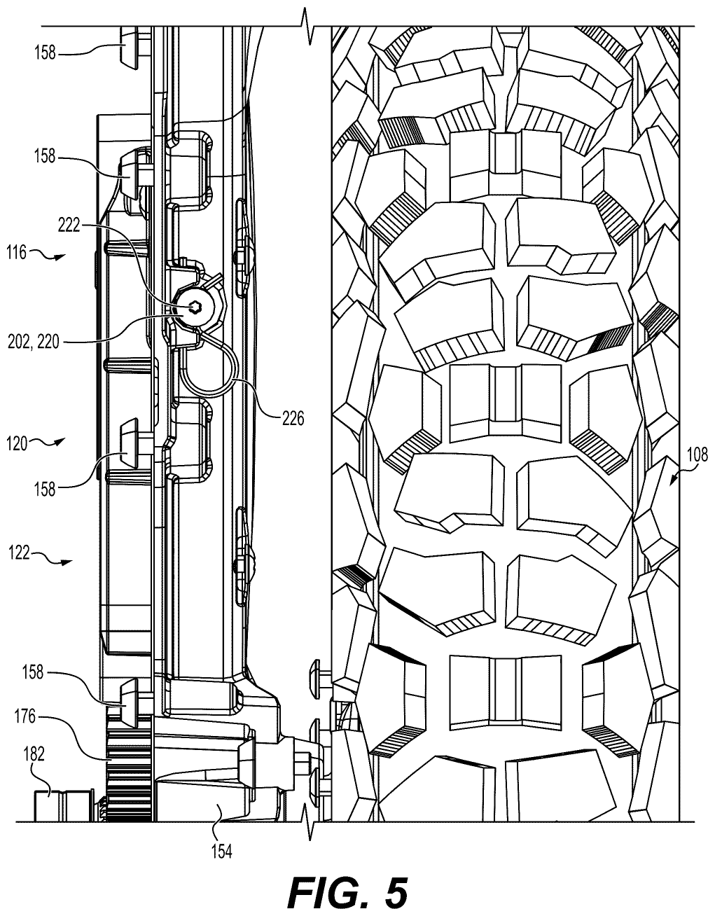

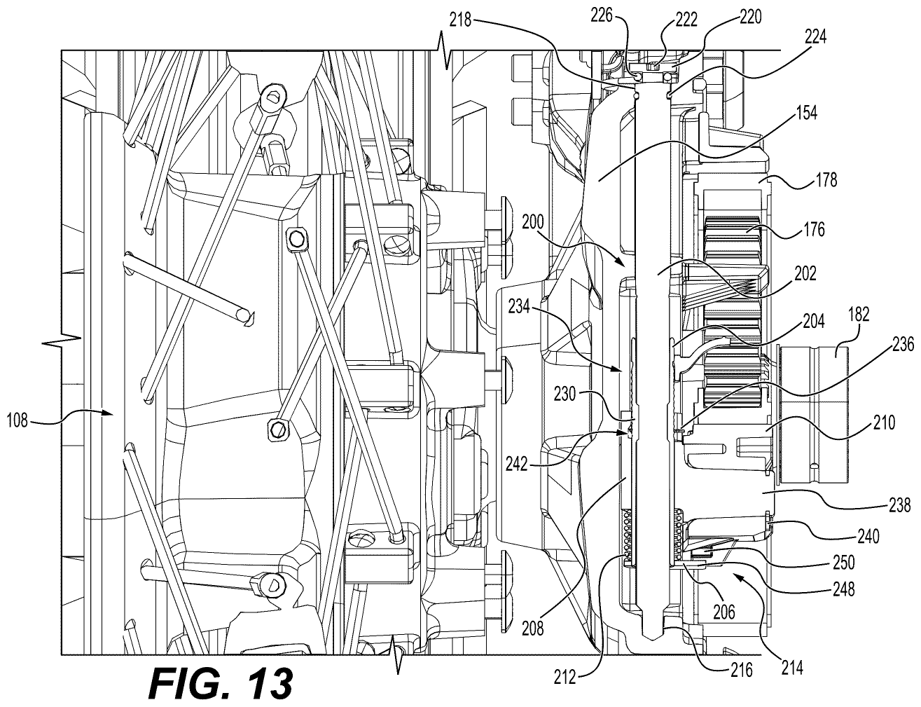

As best seen in FIG. 13, in the present embodiment the actuator 202 is a threaded fastener having a lower end received in a recess 216 defined in the main housing portion 154 and an upper portion extending through an aperture 218 defined in the main housing portion 154. The actuator 202 has a head 220 defining a socket 222. A ring seal 224 is provided between the upper portion of the actuator 202 and the part of the main housing portion 154 defining the aperture 218. A spring clip 226, best seen in FIG. 5, is connected to the actuator 202 below the head 220 to prevent the actuator 202 from moving vertically in the housing 122. As best seen in FIGS. 2 and 3, the housing 122 defines an aperture 228 in a top of the main housing portion 154. As seen in FIGS. 4, 10 and 12, the aperture 228 is aligned with the head 220. As will be described in more detail below, during maintenance of the drivetrain 120, a tool, such as a key or a screwdriver, is inserted through the aperture 228 and into the socket 222 to turn the actuator 200.

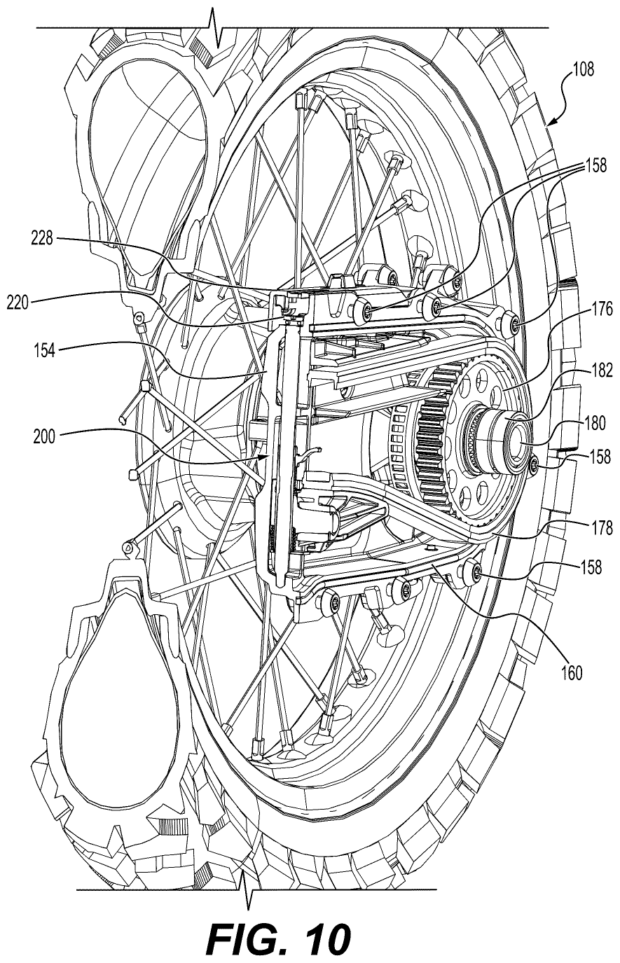

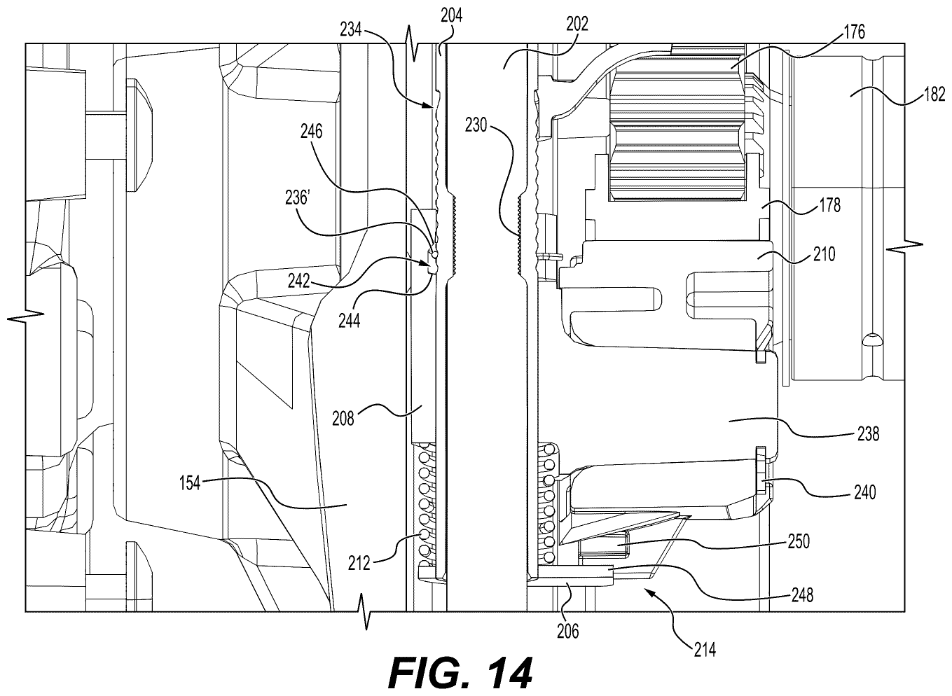

With reference to FIGS. 10 and 14, the translation member 204 is a generally tubular member. The translation member 204 has internal threads 230 engaging the external threads of the actuator 202. The lower end of the translation member 204 is connected to the base 206 which abuts walls 232 defined by the main housing portion 154, thereby preventing the translation member 204 from rotating around the actuator 202. As a result of the threaded engagement between the actuator 202 and the translation member 204, turning the actuator 202 translates the translation member 204 and the base 206 together up or down along the actuator 202, depending on the direction of rotation of the actuator 202. An upper external surface of the translation member 204 defines a plurality of grooves 234. The tensioner system 200 also includes a ratchet clip 236, which in the present embodiment is a spring clip, that is received in one of the grooves 234 and, as will be described in more details below, can move from one groove 234 to another.

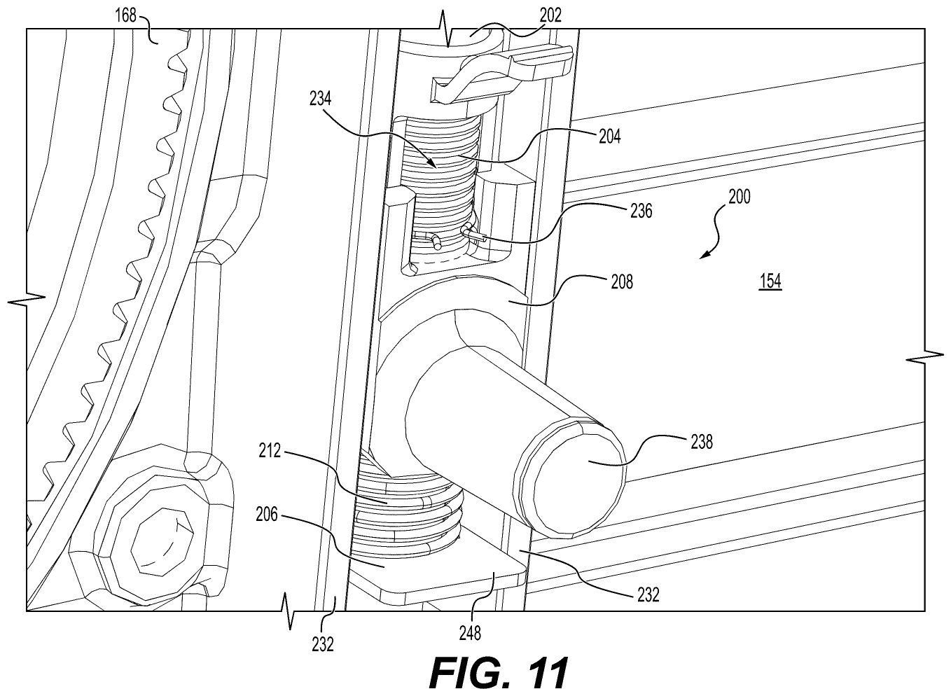

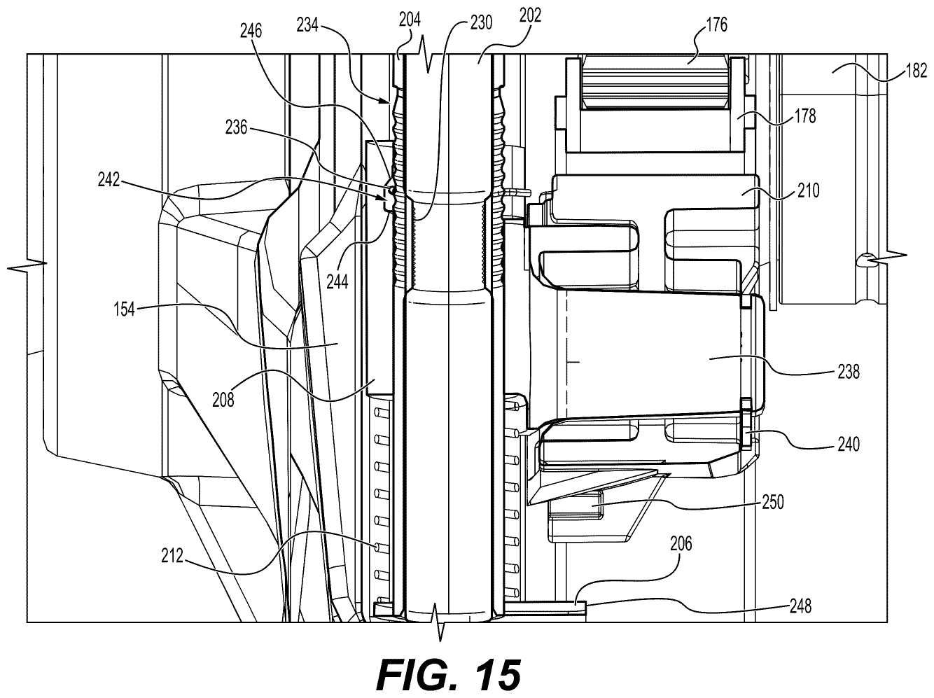

The tensioner body 208 is disposed around the translation member 204 and can translated along the translation member 204. As best seen in FIG. 11, the tensioner body 208 abuts the walls 232, thereby preventing the tensioner body 208 from rotating around translation member 204. The tensioner body 208 defines an axle 238. The slider 210 is disposed on the axle 238 and is pivotable about the axle 238. A C-clip 240 retains the slider 210 on the axle 238. A space 242, best seen in FIG. 14, is defined between the tensioner body 208 and the translation member 204. Part of the ratchet clip 236 is disposed is the space 242. With reference to FIG. 14, the portion of the tensioner body 208 defining the space 242 has a lower horizontal surface 244 and an upper angled surface 246. With the latch 214 in the unlatched position, translation of the tensioner body 208 away from the base 206 (i.e., moving up) causes the surface 244 of the tensioner body 208 to push the ratchet clip 236 from the groove 234 it currently sits in to another higher groove 234 as can be seen by comparing FIG. 15 to FIG. 14. With the latch 214 in the unlatched position, attempts to translate of the tensioner body 208 toward the base 206 (i.e., moving down) causes the surface 246 of the tensioner body 208 to push the against the ratchet clip 236. However, due to the angle of the surface 246, the surface 246 pushes the ratchet clip 236 toward the translation member 204 and into the groove 234 it currently sits in thereby preventing movement of the tensioner body toward 208 the base 206.

In the present embodiment, the biasing member 212 is a coil spring 212 disposed about the lower end of the translation member 204. The spring 212 is disposed between the base 206 and the tensioner body 208 to bias the slider 210 toward the drive belt 178 (i.e., up) via the tensioner body 208. It is contemplated that the biasing member 212 could be something other than a coil spring in other embodiments. For example, it is contemplated that the biasing member 212 could be an elastomeric sleeve or a stack of Belleville washers.

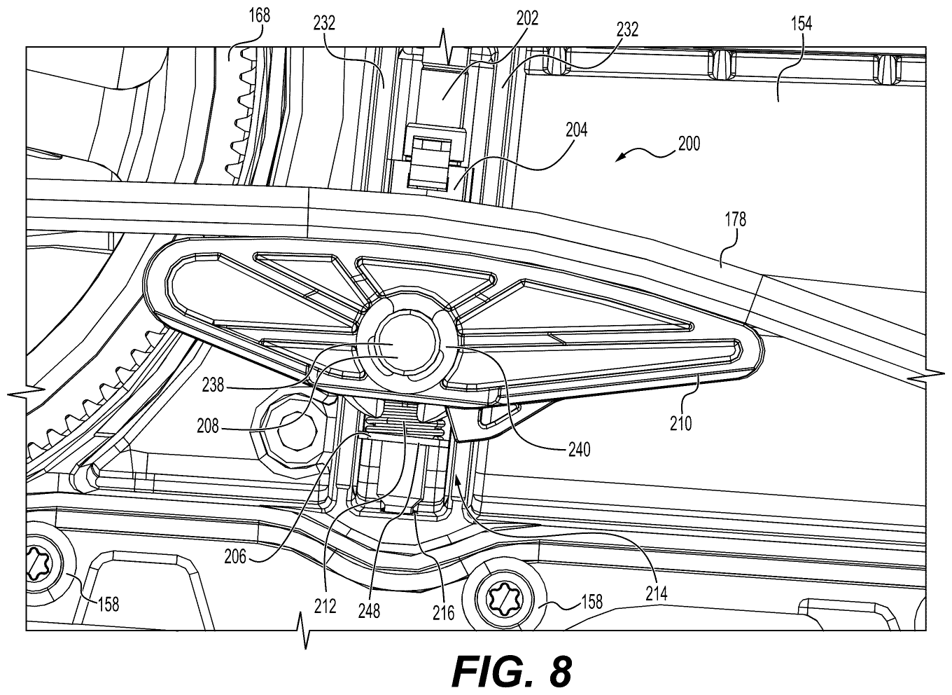

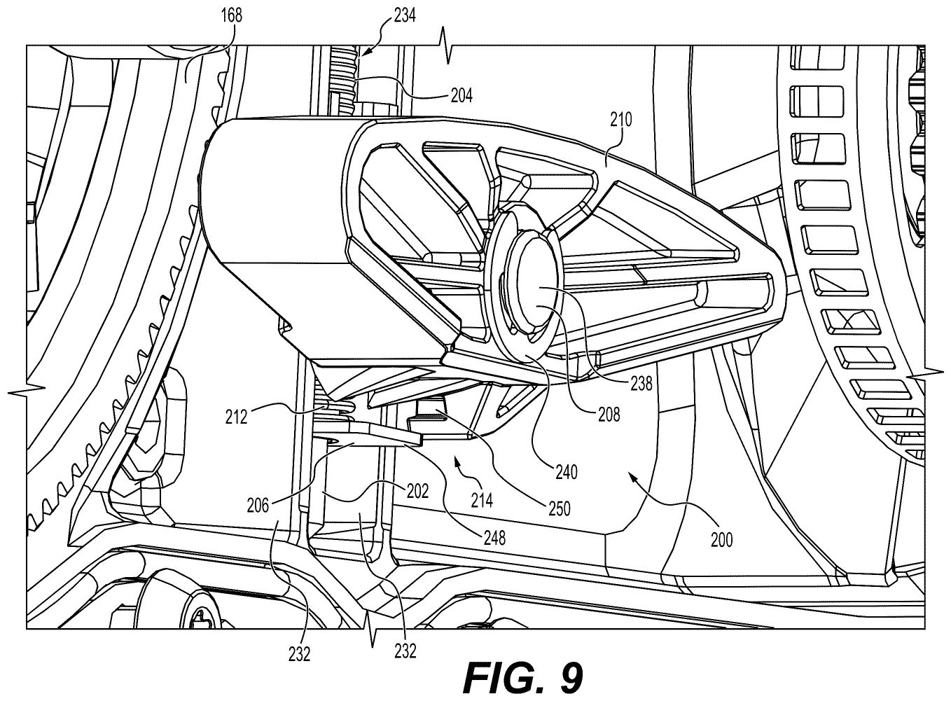

The latch 214 has a latched position and an unlatched position. In the unlatched position, the latch 214 permits the coil spring 212 to move the tensioner body 208 to move the slider 210 toward the drive belt 178 (i.e., up), as will be described in more detail below. In the latched position, the latch 214 prevents the coil spring 212 to move the tensioner body 208 to move the slider 210 toward the drive belt 178, as will be described in more detail below. As will also be described below, the latch 214 is placed in the latched position during maintenance. In the present embodiment, the latch 214 is defined by the base 206 and the slider 210. More specifically, as best seen in FIGS. 9 and 14, the base 206 defines a tab 248 and the slider 210 defines a recess 250, which together define the latch 214. In the unlatched position of the latch 214, the tab 248 is disengaged from the recess 250, and as such, the slider 210 is disengaged from the base 206, as seen in FIGS. 8, 9 and 13 to 15, and the tensioner body 208 is movable relative to the base 206. In the latched position of the latch 214, the tab 248 is received in the recess 250, and as such, the slider 210 engages the base 206, as seen in FIG. 6, and the tensioner body 208 is fixed relative to the base 206. The slider 210 pivots about the axle 238 to engage and disengage the tab 248 with the recess 250. It is contemplated that in some embodiments, the slider 210 could defined the tab 248 and the base 206 could define the recess 250. It is also contemplated that is some embodiments, the latch 214 could be a component that is completely independent of the base 206 and the slider 210, or could be defined by only one of the base 206 and the slider 210 in combination with other components.

The operation of the tensioner system 200 will now be described. When the vehicle 100 is not stopped for maintenance and when the drivetrain 120 is to be used to transfer torque from the motor 114 to the rear wheel 108, the latch 214 is in the unlatched position. With the latch in the unlatched position, the spring 212 pushes up on the tensioner body 208 and, as a result, the slider 210 pushes up on the bottom of the drive belt 178 to apply tension to the drive belt 178, as shown in FIGS. 8, 13 and 14. During use of the drivetrain 120, when the tension in the drive belt 178 reduces sufficiently for the spring 212 to overcome the downward force applied by the belt 210 on the slider 210 and to apply a sufficient force to displace the ratchet clip 236, the spring 210 pushes the tensioner body 208 up to cause the tensioner body 208 to translate up along the translation member 204, thereby causing the surface 244 to push the ratchet clip 236 from its current groove 234 to another higher groove 234, as shown in FIG. 15. As the tensioner body 208 translates up along the translation member 204, the slider 210 moves up together with the tensioner body 208 and pushes up on the bottom of the drive belt 178 thereby increasing the tension in the drive belt 178. The tensioner body 208 and the slider 210 continue to move up until the tension in the drive belt 178 is high enough that the force applied by the drive belt 178 on the slider 210 cannot be overcome by the spring 212. Should the tension in the drive belt 178 reduce again sufficiently, the spring 212 will again cause the tensioner body 208 and the slider 210 to move up to increase the tension in the drive belt 178 in the same manner as described above. During use of the drivetrain 120, when the tension in the drive belt 178 increases, the tensioner body 208 translates down along the translation member 204 toward the base 206 until the surface 246 of the tensioner body 208 abuts the ratchet clip 236. As explained above, due to the angle of the surface 246, when the surface 246 of the tensioner body 208 abuts the ratchet clip 236, the ratchet clip 236 prevents further movement of the tensioner body 208 toward the base 206. As can be seen in FIG. 14, the space 244 is taller than the diameter of the ratchet clip 236. As such during use, the tensioner body 208 and the slider 210 can move up and down slightly before the spring 212 pushes the tensioner body 208 up to move the ratchet clip 236 to another groove 234 or before the ratchet clip 236 stops the downward movement of the tensioner body 208 and the slider 210.

To do maintenance on the components of the drivetrain 120 disposed inside the housing 122, such as to change the drive belt 178, prior to removing the housing cover 156, with the vehicle 100 being stopped and the motor 114 being unpowered, a tool is inserted in the aperture 228 of the housing 122 to engage the socket 222 of the actuator 202. The tool turns the actuator 202 in a direction causing the translation member 204 and the base 206 to translate down along the actuator 202. As the translation member 204 and the base 206 move down, the spring 212 expands thereby reducing the force applied by the spring 212. Once the base 206 has moved sufficiently for the spring 212 to reach its full uncompressed length, or a length where on only a small amount of force is applied by the spring 212, the actuator 202 stops to be turned, the tool is removed from the aperture 228, and the housing cover 156 can be removed. Since the spring 212 applies little force on the tensioner body 208, the slider 210 applies little force on the drive belt 178. As such, the resulting tension in the drive belt 178 is smaller than during use of the drivetrain 120. Therefore, the force applied on the rear wheel axle 180 and the bearings 182 should not result in damage to the rear wheel axle 180 and the bearings 182 when the housing cover 156 is removed and the left bearing 182 is no longer supported by the housing cover 156.

With the housing cover 156 removed, the tensioner body 208 and the slider 210 are pushed down toward the base 206 to compress the spring 212. This can be done manually or with the assistance of a tool, depending on the spring rate of the spring 212. To permit this downward movement, the ratchet clip 236 first has to be removed or spread open so as to no longer engage the grooves 234. With the spring 212 compressed, the slider 210 is pivoted to engage the tab 248 in the recess 250, thereby placing the latch 214 in the latched position, as shown in FIG. 6. As a result, the spring 212 is prevented from expanding and the slider 210 does not push against the drive belt 178.

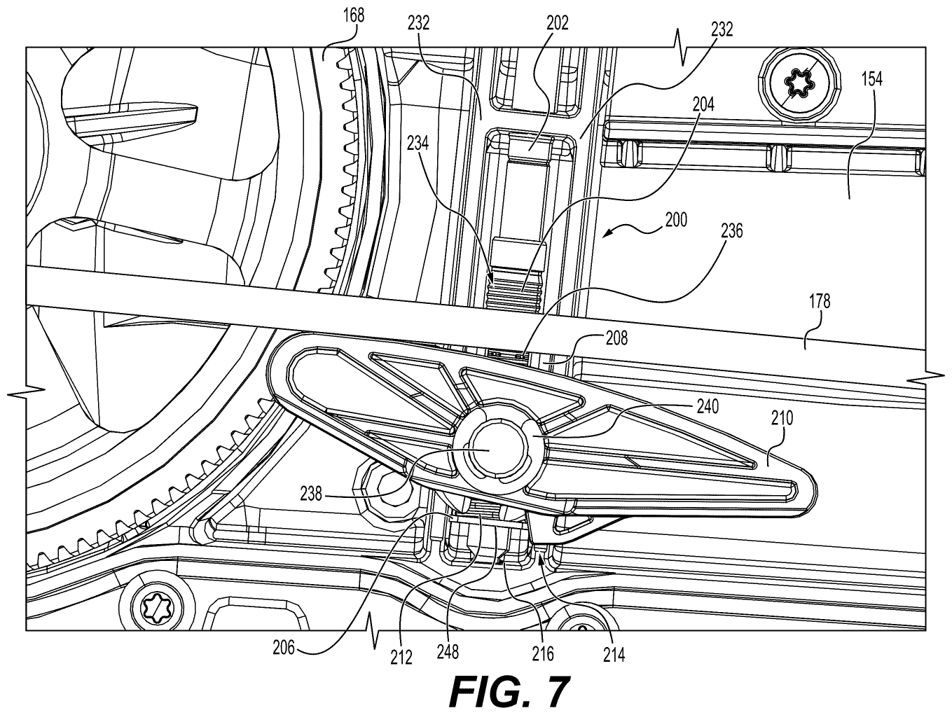

Once the required maintenance to the drivetrain 120 has been performed, the housing cover 156 is reinstalled onto the main housing portion 154 with the latch 214 still in the latched position, such that the tensioner system 200 does not increase the tension in the drive belt 178. If the ratchet clip 236 was removed, the ratchet clip 236 (or a new ratchet clip 236) is to be installed before installing the housing cover 156. Once the housing cover 156 is installed, the tool is inserted in the aperture 228 of the housing 122 to engage the socket 222 of the actuator 202. The tool turns the actuator 202 in a direction causing the translation member 204, the base 206, the tensioner body 208, the slider 210 and the spring 212 to translate up as a unit along the actuator 202. As the translation member 204, the base 206, the tensioner body 208, the slider 210 and the spring 212 move up, the slider 210 moves toward the drive belt 178. As these components continue to move up, a front portion of the slider 210 eventually comes into contact with the drive belt 178 as shown in FIG. 7, and the contact with the drive belt 178 causes the slider 210 to pivot (clockwise with reference to FIG. 7), thereby disengaging the tab 248 from the recess 250 and placing the latch 214 in the unlatched position. Once the latch 214 is in the unlatched position, the spring 212 expands and pushes the tensioner body 208 and the slider 210 up, causing the slider 210 to push against the bottom of the drive belt 178, thereby increasing the tension in the drive belt 208. The tensioner body 208 and the slider 210 continue to move up until the tension in the drive belt 178 is high enough that the force applied by the drive belt 178 on the slider 210 cannot be overcome by the spring 212, and the ratchet clip 236 is received in the corresponding groove 234, such as in FIGS. 8 and 14. Once the latch 214 has moved to the unlatched position, the tool is removed from the aperture 228. The tensioner system 200 is now configured to operate as described above to maintain tension in the drive belt 178 during use of the drivetrain 120.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

What is claimed is:

1. A tensioner system for a flexible drive member comprising:
a slider configured for abutting the flexible drive member;
a tensioner body supporting the slider;
a biasing member arranged for biasing the slider toward the flexible drive member via the tensioner body; and
a latch having a latched position and an unlatched position,
in the unlatched position, the latch permitting the biasing member to move the slider toward the flexible member, and
in the latched position, the latch preventing the biasing member from moving the slider toward the flexible member.

2. The tensioner system of claim 1, further comprising a base selectively engaging the slider;
wherein:
in the unlatched position, the slider is disengaged from the base, and the tensioner body is movable relative to the base; and
in the latched position, the slider engages the base, and the tensioner body is fixed relative to the base.

3. The tensioner system of claim 2, wherein the biasing member is a spring disposed between the base and the tensioner body.

4. The tensioner system of claim 2, wherein the latch comprises:
a tab defined by one of the base and the slider; and
a recess defined by an other one of the base and the slide,
in the unlatched position, the tab is disengaged from the recess, and
in the latched position, the tab is received in the recess.

5. The tensioner system of claim 4, wherein:
the base defines the tab; and
the slider defines the recess.

6. The tensioner system of claim 4, wherein the slider pivots to engage and disengage the tab with the recess.

7. The tensioner system of claim 6, further comprising an actuator operatively connected to the base, the tensioner body, and the slider for selectively translating the base, the tensioner body, and the slider relative to the flexible drive member;
wherein in the latched position, the actuator is configured to move the base, the tensioner body, and the slider as a unit toward the flexible drive member such that the slider comes into contact with the flexible drive member, causing the slider to pivot thereby disengaging the tab from the recess and placing the latch in the unlatched position.

8. The tensioner system of claim 7, further comprising a translation member having threads;
wherein:
the base is connected to the translation member;
the tensioner body is supported by the translation member,
in the unlatched position, the tensioner body is translatable along the translation member, and
the actuator is a threaded fastener having threads engaging the threads of the translation member.

9. The tensioner system of claim 8, wherein:
the translation member defines a plurality of grooves;
a space is defined between the tensioner body and the translation member;
the tensioner system further comprises a ratchet clip disposed at least in part in the space and received in one groove of the plurality of grooves;
translation of the tensioner body away from the base causing the tensioner body to push the ratchet clip from the one groove to an other groove of the plurality of grooves, the other groove of the plurality of grooves being further from the base than the one groove; and
the ratchet clip prevents movement of the tensioner body toward the base.

10. A drive train comprising:
a housing;
a drive wheel disposed in the housing;
a driven wheel disposed in the housing;
a flexible drive member engaging the drive wheel and the driven wheel for transmitting torque between the drive wheel and the driven wheel; and
a tensioner system for tensioning the flexible drive member, the tensioner system comprising:
a slider for abutting the flexible drive member;
a tensioner body supporting the slider;
a biasing member arranged selectively biasing the slider toward the flexible drive member via the tensioner body;
a latch having a latched position and an unlatched position,
in the unlatched position, the latch permitting the biasing member to move the slider toward the flexible member,
in the latched position, the latch preventing the biasing member from moving the slider toward the flexible member; and
an actuator operatively connected to the latch for moving the latch from the latched position to the unlatched position.

11. The drivetrain of claim 10, wherein:
the housing defines an aperture; and
the actuator is accessible via the aperture for moving the latch from the latched position to the unlatched position.

12. The drivetrain of claim 10, wherein:
the tensioner system further comprises a base selectively engaging the slider;
in the unlatched position, the slider is disengaged from the base, and the tensioner body is movable relative to the base; and
in the latched position, the slider engages the base, and the tensioner body is fixed relative to the base.

13. The drivetrain of claim 12, wherein the biasing member is a spring disposed between the base and the tensioner body.

14. The drivetrain of claim 12, wherein the latch comprises:
a tab defined by one of the base and the slider; and
a recess defined by an other one of the base and the slide,
in the unlatched position, the tab is disengaged from the recess, and
in the latched position, the tab is received in the recess.

15. The drivetrain of claim 14, wherein:
the base defines the tab; and
the slider defines the recess.

16. The drivetrain of claim 14, wherein the slider pivots to engage and disengage the tab with the recess.

17. The drivetrain of claim 16, wherein:
the actuator is operatively connected to the base, the tensioner body, and the slider for selectively translating the base, the tensioner body, and the slider relative to the flexible drive member;
in the latched position, the actuator is configured to move the base, the tensioner body, and the slider as a unit toward the flexible drive member such that the slider comes into contact with the flexible drive member causing the slider to pivot thereby disengaging the tab from the recess and placing the latch in the unlatched position.

18. The drivetrain of claim 17, wherein:
the tensioner system further comprises a translation member having threads;
the base is connected to the translation member;
the tensioner body is supported by the translation member,
in the unlatched position, the tensioner body is translatable along the translation member, and
the actuator is a threaded fastener having threads engaging the threads of the translation member.

19. The drivetrain of claim 18, wherein:
the translation member defines a plurality of grooves;
a space is defined between the tensioner body and the translation member;
the tensioner system further comprises a ratchet clip disposed at least in part in the space and received in one groove of the plurality of grooves;
translation of the tensioner body away from the base causing the tensioner body to push the ratchet clip from the one groove to an other groove of the plurality of grooves, the other groove of the plurality of grooves being further from the base than the one groove; and
the ratchet clip prevents movement of the tensioner body toward the base.

20. A vehicle comprising:
a frame;
at least one front wheel;
a rear wheel;
the drivetrain of claim 10, the driven wheel of the drivetrain being operatively connected to the rear wheel; and
a motor operatively connected to the drive wheel of the drivetrain.
